(19) United States
(12) Patent Application Publication
(10) Pub. No.: US 2007/0082970 A1
(43) Pub. Date: Apr. 12, 2007

(54) Adhesives and their applications

(76) Inventors: Edward Zbygniew Nowak, Cambridge (GB); Jason Teckoe, Cambridgeshire (GB)

Correspondence Address: MCDERMOTT, WILL & EMERY LLP, 227 WEST MONROE STREET, CHICAGO, IL, 60606-5096, US

(21) Appl. No.: 10/557,361

(22) PCT Filed: May 18, 2004
(86) PCT No.: PCT/GB04/02141

§ 371 Date: Nov. 18, 2005

(30) Foreign Application Priority Data
May 19, 2003 (GB) 0311440.2
Aug. 8, 2003 (GB) 0318655.8

(51) Int. Cl. A23B 7/16

(52) U.S. Cl. 523/100

(57) ABSTRACT

Adhesive compositions and their applications are disclosed. Further, apparatus suitable for applying glue is also disclosed and which can be used for sealing or welding non-gelatin films to achieve strong tamper proof and leak free welds. Products thus produced include capsules, pouches and other packaging constructions. Other products include tables, powders and compacted powders enrobed by films. The films, adhesives and film modifying compositions used can be safe for human consumption and may find use as a wall material of an ingestible delivery capsule, e.g. containing a dose of a pharmaceutical preparation.

### FIELD OF THE INVENTION

This invention relates to adhesive compositions and their applications and more particularly adhesives applied by a certain type of apparatus and which is for use with non gelatine polymers, e.g. HPMC, HPC, PEO, PEO-PEG graft copolymers or PVOH materials or their derivatives or mixtures thereof.

### BACKGROUND OF THE INVENTION

HPMC is a synthetic plastics material, which is a chemically modified form of the naturally occurring polymer, cellulose. Films (or sheets or membranes) of HPMC are available commercially and have various uses, including proposals for use as wall materials for delivery capsules i.e. capsules designed to retain and protect their contents until an intended site of delivery or conditions of delivery are encountered, at which the contents of the capsule are released. HPMC is suitable for ingestion by humans, so delivery capsules with HPMC walls find the potential use as ingestible capsules, e.g. for the delivery of accurately metered doses of pharmaceutical preparations and dietary supplements, as a possible replacement for gelatine based capsules. See for example, WO 97/35537, WO00/27367 and WO01/03676. HPMC can be used to encapsulate, such as pharmaceuticals or food supplements like fish oils.

Solutions containing HPMC, acid/or alcohols and water can be used to form an internal adhesive which when the film is used for encapsulating oils, said solutions have the advantage of interacting with the film and chasing the oil from the surface of the film, thereby allowing the film(s) to bond together more effectively, which in an encapsulation process, would aid the sealing and cutting of capsules made from HPMC film, to produce capsules possessing superior properties.

Standard methods for adhesive or glue application included Gravure Roller, Doctor Blade, Slot Coater, or Spray Head. These methods generally apply a uniform coating to the entire surface of the substrate under the coating device, and offer little ability to vary the level of adhesive applied over the surface of the substrate.

Other alternatives, e.g. from the printing industry, that do enable the control over the position and quantity of substrate, are relatively slow and tend to deposit only small quantities of substrate. Additionally, they require a ‘transfer mask’ to be produced for each deposit profile, and as such, on-line control of coating weight is not easily achieved.

By using an apparatus, adapted from inkjet technology, it is possible to not only accurately control the dose of coating applied to the surface of the substrate, but also the location where the coating is applied. This technology therefore allows for a range of different coating profiles (patterns) and levels (quantities) to be applied ‘on-line’ (whilst apparatus is already running) thus enabling improved process control and reproducibility.

In many processes, applying a surface modifying coating to the entire surface of a film could potentially have a detrimental effect on process life, requiring frequent maintenance of process machinery and equipment. Coating residue on parts of machinery and equipment could accumulate and eventually cause the process to fail or at the very least necessitate the regular cleaning of certain parts of the tooling.

The present invention concerns a novel method, apparatus and adhesive compositions for use in connection with polymeric films, such as non-gelatin films, celluosic films, films which are water soluble and or biodegradable HPMC, and further the formation of capsules therefrom.

### SUMMARY OF THE INVENTION

In one aspect of the present invention provides an apparatus for applying glue to polymeric, in a controlled manner. A typical application comprises modifications of known inkjet apparatus (which would otherwise be used e.g. for conventional printing), such as to be able to administer new glue compositions onto sheets of polymeric materials. Such apparatus, is shown, by way of example in FIG. 1. Relatively few modifications are necessary to existing apparatus apart from the mounting of the apparatus above moving sheets of film (rather than printing paper) in a convenient location where the glue is needed, e.g. just prior to the formation of capsules made from the film. The apparatus has been modified to suit new glue formulations which, for example, can have a greater viscosity than typical ink formulations commonly used in inkjet apparatus. For example, the pressures needed for the application of glue may be larger and the glue may be needed to be heated before application in order to give the desired effect. Thus heaters can be incorporated into the apparatus, and also pumps, pipe ways and nozzles can be suitably modified. The apparatus for example may be advantageously computer controlled so that e.g. glue can be applied utilizing complex programmed instructions. Also a computer “eye” may be located above the film proximate to where glue is delivered, so that varying conditions can be monitored e.g. position of capsule forming recesses on a capsule forming drum, or quality of film, so that a suitable glue pattern and quantity can be accurately applied on the polymeric sheet, prior to capsule formation, so that glue patterns may mirror functional features on a capsule forming drum and optimum amounts of glue can be applied to produce the most beneficial result, with little waste of materials and thus little clean-up of waste materials is necessary. For a specific example, as the “eye” could monitor the position of capsule forming recesses on the drum, glue may be applied in a particular pattern onto the film to suit those capsules forming recess positions. As a result, glue may be applied in a circular pattern and in the correct location (on the flat film, on the rim of the capsule forming recesses) just where the capsule seam would be when a capsule is formed.

In another aspect of the present invention provides a method of applying glue to polymeric sheets of film and more particularly HPMC film, and further to a method of producing capsules from such treated film. The said method comprises utilizing the apparatus according to the first aspect of the invention and applying the glue in a controlled manner, for example to sheets of polymer prior to capsule formation. Glue can be applied accurately to where it is needed, utilizing present means of application, facilitated by the accurate metering and application of glue via special glue application nozzles. One advantage of this invention is the economy of glue usage. Another advantage is that complex glue patterns on the film may be achieved, which could mirror capsule shape prior to the manipulation of film for capsule formation. Another advantage is that glue may be applied only where it is needed. Yet another advantage, is that glue may not be (unintentionally) applied where it is not needed thus e.g. limiting the undesirable effects of glue e.g. on the film, where it is not required.

In yet another aspect of the present invention provides novel adhesive compositions. The formulation of an adhesive composition, which may form a surface coating, according to the current application, may differ notably from “normal” glue compositions. Generally, adhesives are relatively high viscosity materials, where it may be necessary to apply heat to reduce their apparent viscosity, in order that they be conveniently applied to a surface. When using apparatus and methods according to the present invention, it is preferable or essential to use lower or low viscosity compositions, as fouling of the glue application head (equivalent to a printing head), by glue residue, can easily occur if the viscosity of the solution is too high.

For the application of a surface modifying coating or glue, it is preferable to use a coating formulation that has compatibility with the underlying substrate, which, in this case is PVOH or a cellulosic material.

A suitable glue composition may comprise the following components:

Solvent:

Low molecular weight alcohols, gamma valerolactone, butyl valerolactone, pyrrolidones, (n-methyl or n-octyl) and glycols (propylene) and water. In particular, the use of low molecular weight alcohols, such as ethanol, isopropanol, n-propanol, or benzyl alcohol are preferred, for their ability to rapidly modify the film surface, making it suitable for bonding. This component can affect drying times and viscosity of the composition.

Modifier or Moderator:

The choice of moderator/surface modifier may be critical to ensure that a suitable bond is produced between adjacent substrates. This component can also affect drying times and viscosity of the composition. Organic compounds such as lower molecular weight PEG, propylene glycol or glyceryl acetates (mono, di or tri) have proven suitable materials.

Charge Carrier

A suitable charge carrier may be a salt of an organic compound. A charge carrier, such as an organic acid, e.g. as a carboxylic acid or derivative may be useful, e.g. lactic acid or sodium lactate or a salt of an organic compound, e.g. an alkali metal salt of alcohols or acids, e.g. sodium, potassium or calcium salts of organic acids or alcohols, e.g. sodium ethanoate. Other suitable charge carriers may be inorganic alkali metal salts. It may be useful to use a mixture of charge carriers to usefully obtain the desired result, e.g. the correct charge.

Therefore, a glue composition suitable for use may comprise:

a). 0-40 w/w %, or more preferably 0-10 w/w % of a charge carrier, such as one or more an organic acids such as a carboxylic acids or derivatives thereof, e.g. lactic acid, potassium or sodium lactate and/or an inorganic salt.

b). 30-90 w/w %, preferably, 40-85 w/w % of a solvent e.g. to carry the mixture, e.g. benzyl alcohol and/or water.

c). 10-60 w/w %, preferably 20-50 w/w % of a moderator/modifier, e.g. for moderating the effects of the solvent/charge carrier, e.g. Triacetin or a soluble non gelatin polymer, such as a cellulosic polymer, or any other compound which as a buffering or softening effect, reducing the aggressive character of the solvent.

The mixture is so designed to be fully compatible and effective so as to perform its function.

Lactic acid is miscible with Triacetin, which in turn is a good mix with benzyl alcohol.

Compositions according to the present invention can be used to:

1) Laminate 2 HPMC films together

2) Coat the surface of an HPMC film

3) Chase oil off films and improve the film's sealing capability during the encapsulation process.

Formulations according to the present invention include the following advantages:

1) A formulation that can modify the surface of a film to enable that film to bond together under pressure and/or heat e.g. lamination.

2) A formulation which can modify the surface of a film to render it hydrophilic and chase oil from that surface to enable oil filled capsules to be produced.

3) A formulation that can be modified so as the rate that it is absorbed into the film can be controlled to aid processing of capsules and laminates.

An important aspect in the formation of capsules from PVOH or HPMC is the glue that is used and the way that it is applied to the materials. A single uniform coat of glue can be applied to the film materials, e.g. by a slot coater, whereby a uniform film of glue is applied under pressure, through a narrow slot, e.g. of width less than 50 microns. The slot is positioned, at a specific distance above the travelling film, and the quantity of glue supplied is dictated by the viscosity of the glue, the pressure behind the glue introduced into the slot, and the speed of the travelling film under the slot. As viscosity of glue is often dependent on temperature, it follows that the temperature of the glue supplied in the apparatus, is a very important factor. As larger quantities of glue are needed by this method of coating film, scrapers are required to ensure that the thickness of the glue is uniform, taking the top off any irregularities in the height of the glue applied and guides are also necessary, to keep the flow of the glue directed onto the required film area. Even with the above measures taken, there are disadvantages with the slot coater method. As compared to, and unlike methods that may apply glue more locally to where it is needed perhaps most e.g. nearer where capsule seam formation is to occur, much larger quantities of glue are needed and because of this quantity of glue, there is also a problem of excess glue, waste and fouling of the machinery with glue. Such waste and fouling can be at a maximum, for example, when the machine is stopped for any reason. The flow of glue continues and the apparatus often has to be cleaned before it is started up again.

An alternative to slot coating is a method of accurately metering and applying glue via jets, whereby the glue is accurately applied, in the necessary amounts, to where it is needed most, i.e. to areas at or near capsule seam formation. This method derives its principle from ink-jet technology, now well advanced and perhaps superseded in some areas of printing, but nevertheless finds novel application here. The present method and apparatus has important differences and objectives however, to the problems posed and the technical hurdles to be faced in the conventional printing field. Whereas the “print” to be provided in the printing field has to be presentable, readable or to have aesthetic appeal, the products to be provided in the present invention are e.g. capsules with capsule seals of sufficient quality and strength, or e.g. enrobed tablets or slugs of compressed powder coated with films which have a high quality tamper evident seal. The accuracy of the positioning of the glue-jets and the quantity of glue to be provided are important factors to be considered when one needs to produce a viable seal of sufficient quality, especially for the production, e.g. of pharmaceutical dosage forms, which have to meet the appropriate high standards necessary (legal/commercial). Also, the ultimate consumer will typically be a discerning one, and the high quality seals provided by the present invention, will have an advantage here.

### EXAMPLE 1

An adhesive composition is produced by preparing mixing benzyl alcohol and glyceryl triacetate and dissolving sodium lactate in the composition. The composition produced comprised 50% benzyl alcohol, 49% glyceryl triacetate and 1% sodium lactate. The composition was then introduced into an inkjet head and so applied to a film to produce a pattern of adhesive on the film.

### EXAMPLE 2

A mixture of 35% ethanol and 50% benzyl alcohol was made up and 8% of sodium lactate was added and dissolved in the solution. Various other components were optionally added to bring the weight % age up to 100%. The solution was then used and charged into a modified inkjet apparatus as depicted in FIGS. 1 and 2. Tablets which were partially enrobed with plasticized HPMC film, had adhesive applied by said apparatus, to the enrobed sidewall(s) of each tablet and a second film of HPMC was then applied to the tablet, said second film overlapping the first film, such that the adhesive applied aids the bonding and the sealing of the two films together, so producing a fully enrobed and sealed tablet.

### DESCRIPTION OF THE DRAWINGS

The drawings are intended in no way to limit the scope of the invention.

FIG. 1 shows the way in which the present invention may be used to apply a composition using e.g. apparatus according to the present invention to apply an adhesive to a dosage form such as a tablet or compacted powder slug.

FIG. 2 shows how an array of inkjets can be arranged to apply e.g. adhesive or solvent to a series of dosage forms, in this instance, in a lined formation.

FIG. 3 shows a graph demonstrating how ink (adhesive composition) density applied affects the shredding of the bond produced, by the application of an adhesive composition to the film.

FIG. 4 shows how an inkjet head may be positioned to apply a pattern of adhesive to a film e.g. for use in enrobing pharmaceutical dosage forms.

FIGS. 5 and 6 shows the various patterns which may be applied to a film by the present method, for the advantageous use of the film in conveniently producing superior dosage forms, facilitated by the accurate application of e.g. small droplets of adhesive to form very “tight” and distinct areas of application to suit very specific needs.

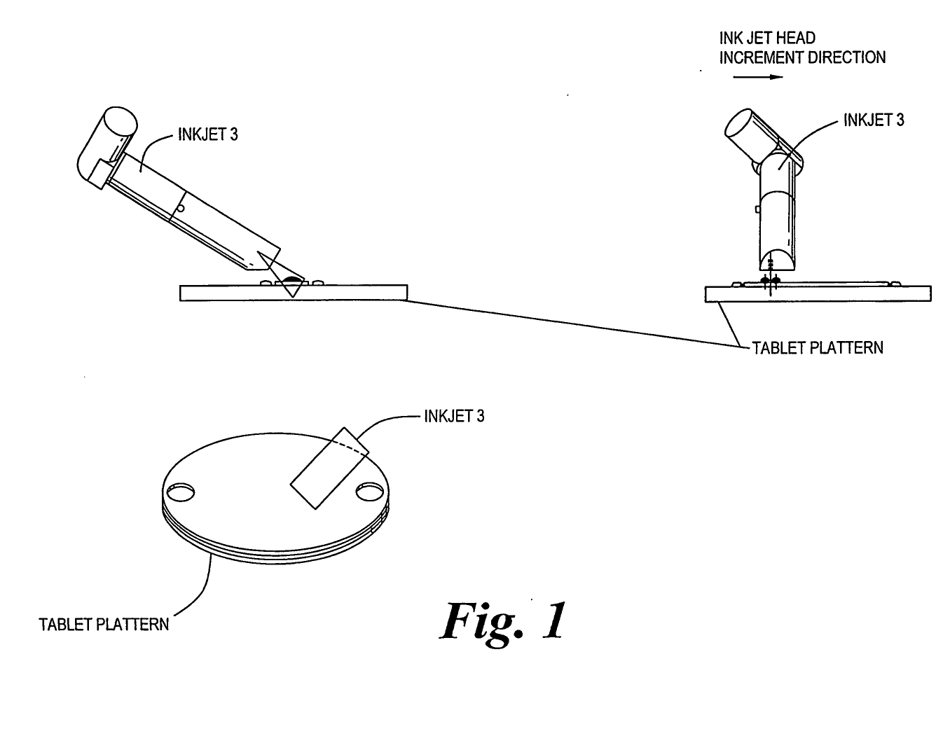

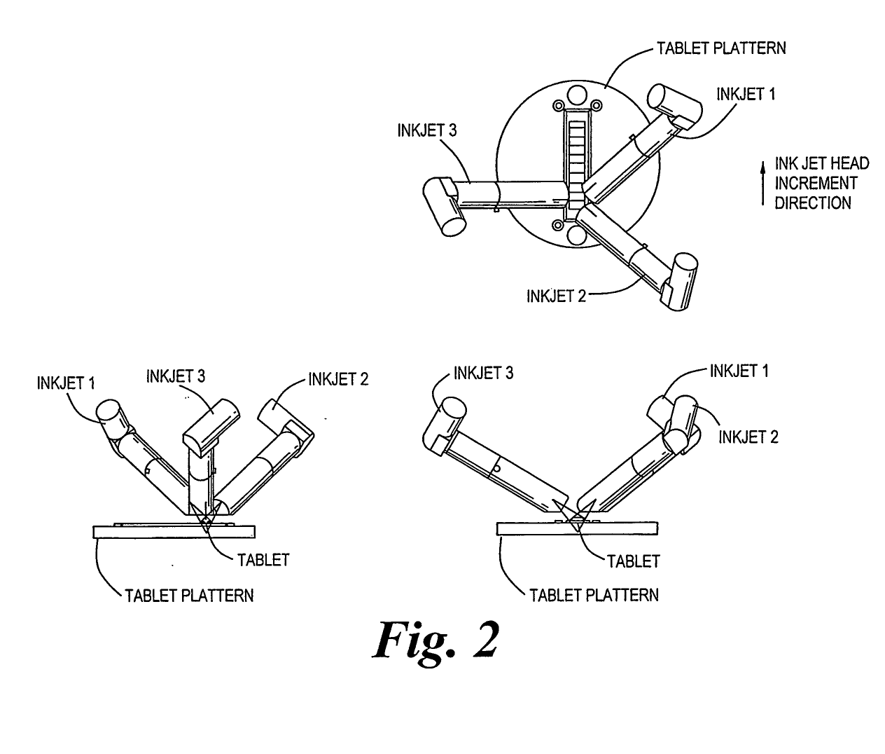

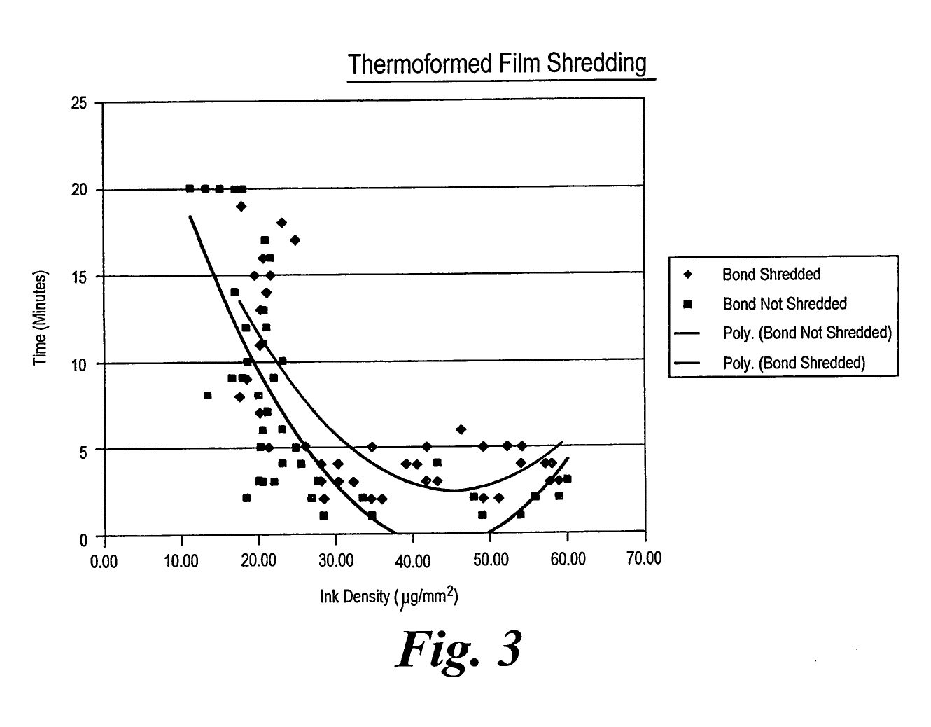

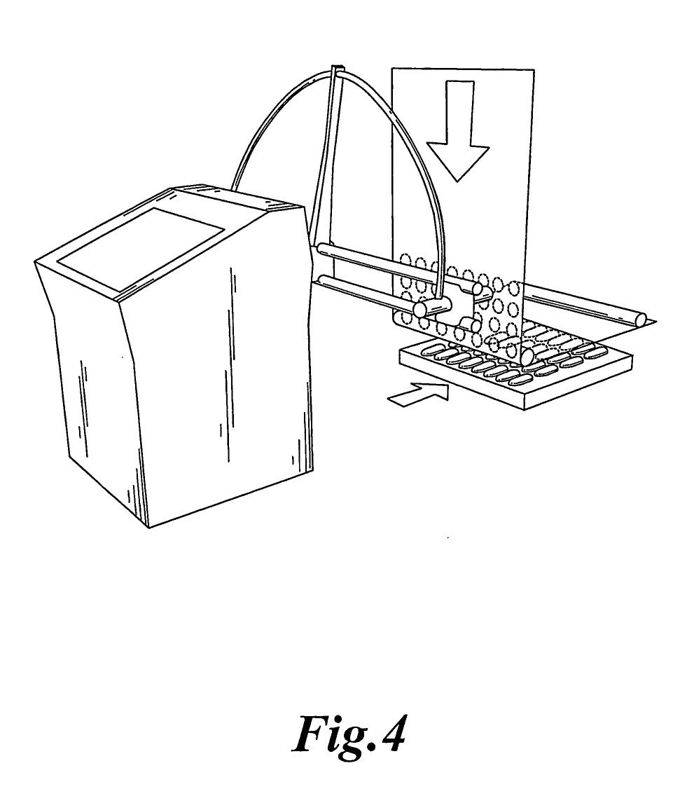

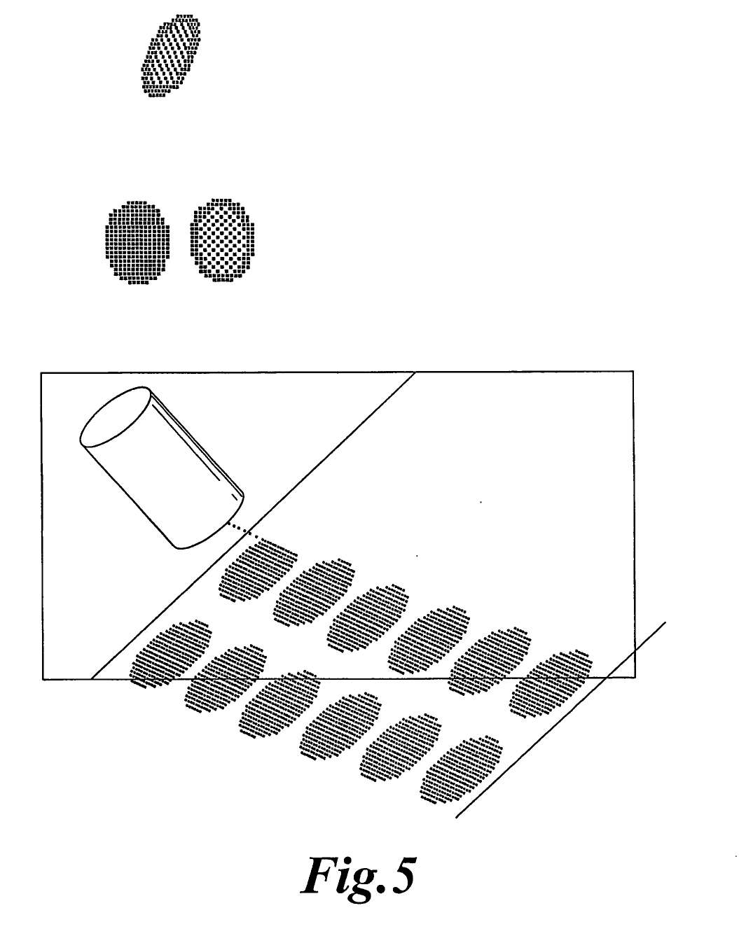

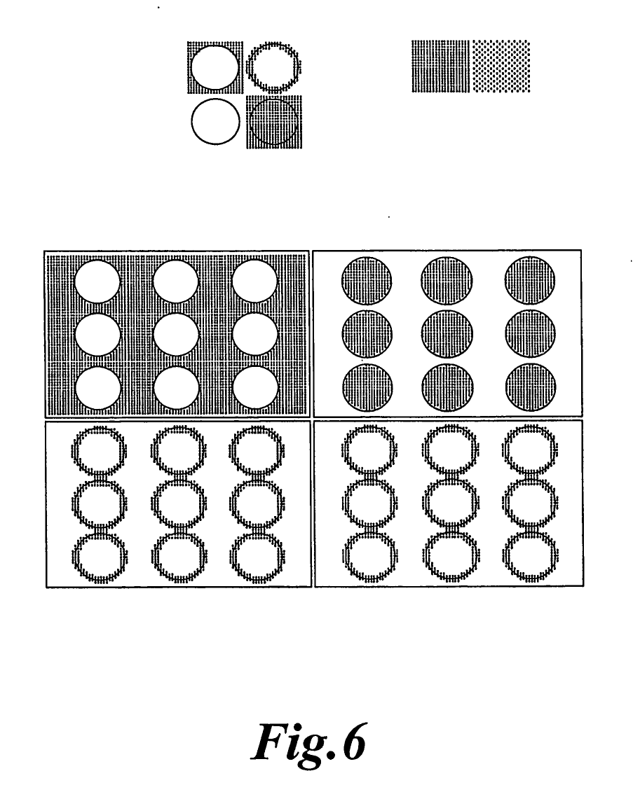

1. A method of producing a product comprising a polymeric material including the step of applying an adhesive to a film using an ‘ink-jet’ type apparatus.

2. A method according to claim 1 wherein the film is non gelatine water soluble.

3. A method according to claim 1 wherein the film is biodegradable.

4. A method according to claim 1 wherein the film is ingestible.

5. A method according to claim 1 wherein using the ‘ink-jet’ type apparatus, the apparatus is used to seal or weld a capsule during capsule formation.

6. A method according to claim 1 wherein using the ‘ink-jet’ type apparatus, the apparatus is used to make a seal or weld to complete the film enrobing process of a tablet or compacted powder slug.

7. A method according to claim 6 wherein applying the adhesive further comprises applying the adhesive to a sidewall of the tablet.

8. A method according to claim 7 wherein applying the adhesive further comprises applying the adhesive to the sidewall of the tablet partially enrobed with a first film to aid the bonding with a second film.

9. A method according to claim 5 wherein applying the adhesive further comprises applying the adhesive at or near the seal.

10. A method according to claim 1 wherein the applying of the adhesive, the amount of the adhesive applied to the film is the range of between 10-30 gsm.

11. An apparatus for producing a product comprising a polymeric material and supplying an adhesive to a film, comprising: a jet adapted to apply the adhesive to the film.

12. An apparatus as claimed in claim 11 wherein the apparatus comprises at least two jets.

13. An apparatus as claimed in claim 11 wherein the adhesive has greater viscosity than ink.

14. An apparatus as claimed in claim 11 further comprising heaters to heat the adhesive before application of the adhesive on the film.

15. An apparatus as claimed in claim 11 wherein the apparatus is adapted to apply a pattern of adhesive on the film.

16. An apparatus as claimed in claim 11 further comprising a monitor proximate to where the adhesive is to be delivered on the film, to monitor the application of the adhesive on the film.

17. An apparatus as claimed in claim 16 wherein the pattern is circular.

18. An apparatus as claimed in claim 11 wherein the film is non gelatine water soluble.

19. An apparatus as claimed in claim 11 wherein the film is biodegradable.

20. An apparatus as claimed in claim 11 wherein the film is ingestible.

21. An adhesive composition for sealing, bonding or welding soluble or ingestible films comprising: one or more chemical species which aids in directing the path of adhesive being ejected from a remote position or positions, and which travels through open space, with the adhesive, to a surface or surfaces where the adhesive is required; and an adhesive.

22. An adhesive composition for associating, sealing or welding soluble or ingestible polymeric films comprising: a charge carrier; and an adhesive and/or solvent.

23. An adhesive composition for associating, sealing or welding soluble or ingestible polymeric films comprising: a charge carrier an adhesive and/or solvent; and a moderator.

24. An adhesive composition according to claim 21 wherein the adhesive comprises a solvent.

25. An adhesive composition according to claim 23 wherein the moderator is Triacetin and/or water.

26. An adhesive composition according to claim 21 wherein the adhesive comprises one or more organic solvents and/or water.

27. An adhesive composition according to claim 21 wherein the adhesive also comprises an organic polymer.

28. (canceled)

29. A dosage form as claimed in claim 28 wherein the dosage form has an overlap seal.

30. A dosage form comprising content material retained by a film and an adhesive composition applied to the film wherein the adhesive composition is an adhesive composition for sealing, bonding or welding soluble or ingestible films comprising: one or more chemical species which aids in directing the path of adhesive being ejected from a remote position or positions, and which travels through open space, with the adhesive, to a surface or surfaces where the adhesive is required; and an adhesive.

31. A dosage form comprising content material retained by a film and an adhesive composition applied to the film wherein the adhesive composition is applied to the film in accordance with a method of producing a product comprising a polymeric material including the step of applying an adhesive to a film using an ‘inkjet’ type apparatus.

32. A dosage form comprising content material retained by a film and an adhesive composition applied to the film wherein the dosage form is produced by an apparatus for producing a product comprising a polymeric material and supplying an adhesive to a film, comprising: a jet adapted to apply the adhesive to the film.
